(19) United States
(12) Patent Application Publication
(10) Pub. No.: US 2009/0186256 A1
(43) Pub. Date: Jul. 23, 2009

(54) RECEPTACLE

(75) Inventor: Yasuyuki Iida, Aichi (JP)

Correspondence Address: KENYON & KENYON LLP, 1500 K STREET N.W., SUITE 700, WASHINGTON, DC, 20005, US

(73) Assignee: Panasonic Corporation, Osaka (JP)

(21) Appl. No.: 12/374,839

(22) PCT Filed: Jul. 17, 2007
(86) PCT No.: PCT/JP2007/064387

§ 371 Date: Jan. 23, 2009

(30) Foreign Application Priority Data
Aug. 25, 2006 (JP) 2006-228817

(51) Int. Cl. H01M 2/02

(52) U.S. Cl. 429/34

(57) ABSTRACT

A receptacle including a structure for connecting a mobile object having a supply port with a fuel supply device connected to the supply port to supply the mobile object with fuel and external power is provided. The fuel supply device is provided with a first conductive portion containing the supply port when being connected, and supplying the mobile object with the fuel via a fuel supply channel formed therein, a second conductive portion provided on the outer peripheral side of the first conductive portion to supply the mobile object with the external power when being connected, an insulating portion electrically insulating the first conductive portion from the second conductive portion, and a ground line grounding the first conductive portion.

### TECHNICAL FIELD

The present invention relates to a receptacle having a structure for connecting a mobile object with a fuel supply device to supply the mobile object with fuel and external power.

### BACKGROUND ART

Fuel cell vehicles, such as a fuel cell automobile which travels using the electrical energy which a fuel cell outputs, will receive supply of fuels, such as hydrogen, from a fuel supply device. A technique of connecting an electric signal connector to thereby make connection work simple and easy in order to transfer an electric signal showing the states (for example, temperature, pressure, etc. of a tank for storing fuel) of a vehicle at the time of the connection for fuel supply of this fuel supply device is suggested (for example, refer to Japanese Patent Application Laid-Open No. 2003-104498).

### DISCLOSURE OF THE INVENTION

Meanwhile, in a case where fuel is supplied to a vehicle, there is possibility that a battery mounted on the vehicle after fuel is supplied, etc. may be exhausted by the power consumption by power consumption devices (for example, accessories such as a lighting device, an air-conditioner, and a temperature adjusting mechanism, which are mounted on the vehicle) during fuel supply. Particularly in case of a fuel cell vehicle, a high-pressure tank which stores fuel is mounted. When fuel is supplied, the temperature of this tank may be controlled by a temperature adjusting mechanism. Since the power consumption of this temperature adjusting mechanism is large, a battery may be exhausted if the temperature adjusting mechanism continues to be operated during fuel supply. As a result, there is a possibility that the vehicle cannot be started during fuel is supplied.

The invention has been made in view of the above situations, and the object thereof is to provide a receptacle capable of improving the operation stability of a mobile object after fuel is supplied.

In order to achieve the above object, a receptacle of the invention includes a structure for connecting a mobile object having a supply port with a fuel supply device connected to the supply port to supply the mobile object with fuel and external power. The fuel supply device is provided with a first conductive portion containing the supply port when being connected, having a fuel supply channel formed therein, and supplying the mobile object with the fuel via the fuel supply channel, a second conductive portion provided on the outer peripheral side of the first conductive portion to supply the mobile object with the external power when being connected, an insulating portion electrically insulating the first conductive portion from the second conductive portion, and a ground line grounding the first conductive portion.

According to this construction, when the fuel supply device is connected to the supply port of the mobile object, the first conductive portion of the fuel supply device will contain the supply port, thereby supplying the mobile object with fuel via the inner fuel supply channel. Additionally, the second conductive portion which is provided so as to be electrically insulated by interposing the insulating portion on the outer peripheral side of the first conductive portion supplies the mobile object with external power. Consequently, the mobile object can receive external power supply in accordance with supply of fuel.

This prevents the battery of the mobile object from being exhausted even if power consumption devices (for example, accessories, such as a temperature adjusting mechanism) of the mobile object are operated when fuel is supplied. Additionally, since the first conductive portion is grounded by a ground line, static electricity can be removed when being connected with the supply port. Moreover, the fuel supply device has a simple structure which insulates the first conductive portion which supplies the mobile object with fuel, and the second conductive portion which supplies the mobile object with external power by the insulating portion.

Additionally, the first conductive portion may be provided with a conductive spherical body, and a conductive elastic body which biases the spherical body in a direction of the supply port.

According to this construction, the conductive spherical body of the first conductive portion is biased by the conductive elastic body, and connected to the supply port well. As a result, static electricity can be removed by a ground line.

Moreover, the supply port may be provided with a conductive spherical body, and a conductive elastic body which biases the spherical body in a direction of the first conductive portion.

According to this construction, the conductive spherical body of the supply port is biased by the conductive elastic body, and connected to the first conductive portion well. As a result, static electricity can be removed by a ground line.

In addition, the mobile object may be provided with conductive biasing portion connected to the second conductive portion while biasing the fuel supply device in a direction opposite to a connection direction.

The fuel supply device can supply a battery or an accessory of the mobile object with the external power via the second conductive portion.

According to the invention, since a battery of the mobile object is prevented from being exhausted when fuel is supplied, the operation stability of the mobile object after the fuel is supplied can be improved. Additionally, static electricity can be removed at the time of connection between the fuel supply device and the mobile object. Moreover, the structure of the fuel supply device can be made simple.

### BRIEF DESCRIPTION OF THE DRAWINGS

FIG. 1 is a view illustrating a structure of a fuel supply system to which a first embodiment of a receptacle is applied.

FIG. 2 is a view illustrating a construction of the fuel supply device of the fuel supply system.

FIG. 3 is a view illustrating a construction of a fuel cell automobile of the fuel supply system.

FIG. 4 is a sectional view illustrating the first embodiment of the receptacle.

FIG. 5 is a sectional view illustrating a second embodiment of the receptacle.

### BEST MODE FOR CARRYING OUT THE INVENTION

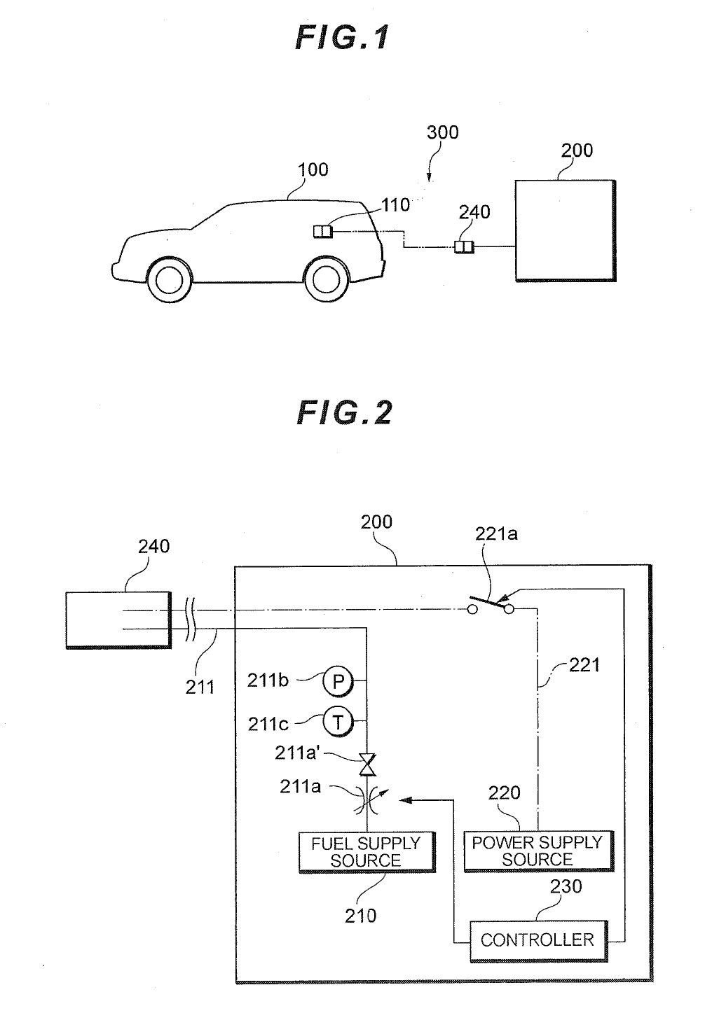

Next, a first embodiment of a receptacle related to the invention will be described with reference to FIGS. 1 to 4.

FIG. 1 is a view illustrating a construction of a fuel supply system 300. The fuel supply system 300 includes a fuel cell automobile (mobile object) 100 which uses hydrogen gas as fuel, and a fuel supply device 200 which supplies the fuel cell automobile 100 with fuel and external power. In addition, although the fuel cell automobile 100 which travels using hydrogen gas as fuel is illustrated here, the receptacle can also be applied to a fuel cell automobile which uses ethanol, etc. as fuel.

Additionally, the receptacle can be applied not only to the fuel cell automobile but to other vehicles, such as a hybrid car and a gasoline-driven car. That is, the fuel of a vehicle may be a gaseous fuel (hydrogen gas, natural gas), or may be a liquid fuel (gasoline, ethanol, light oil, liquid hydrogen). Additionally, the receptacle can be applied not only to the vehicle but to other movable bodies 10, such as a marine vessel or an airplane.

FIG. 2 is a view illustrating a construction of the fuel supply device 200. The fuel supply device 200 includes a fuel supply source 210 for supplying a high-pressure pump (not shown), etc. which pressurizes hydrogen as fuel, and supplies the fuel to a fuel cell automobile when fuel is supplied, a power supply source 220 for supplying external power to the fuel cell automobile 100 when fuel is supplied, and a controller 230 which controls fuel supply and power supply to the fuel cell automobile 100 from the fuel supply device 200.

While hydrogen gas as fuel gas is supplied to the fuel cell automobile 100 via a fuel supply channel 211 from the fuel supply source 210 of the fuel supply device 200, electric power is supplied to the fuel cell automobile 100 via a power supply channel 221 from the power supply source 220 of the fuel supply device 200. A distal end of the fuel supply channel 211 and a distal end of the power supply channel 221 are integrated by a nozzle 240.

This makes it possible to connect the nozzle 240 of the fuel supply device 200 with a fuel receptacle (supply port) 110 provided in the fuel cell automobile 100, thereby simultaneously supplying fuel and electric power to the fuel cell automobile 100 from the fuel supply device 200. This improves the operability of supply operation in the fuel supply device 200.

Here, the fuel supply channel 211 is provided with a flow control valve 211a which controls the flow rate when fuel is supplied to the fuel cell automobile 100, a shutoff valve 211a′ which is “opened” under control by the controller 230 when fuel is supplied, and is “closed” after fuel is supplied, a pressure sensor 211b which detects the pressure when fuel is supplied, and a temperature sensor 211c which detects the temperature when fuel is supplied.

Meanwhile, the power supply channel 221 is provided with a switch 221a which controls on/off, etc. of supply of electric power to the fuel cell 100. The controller 230 performs on/off control of the switch 221a on the basis of, for example, a detection signal of a sensor which detects an attachment/detachment state of the nozzle 240, thereby controlling power supply. Similarly, the controller 230 performs opening/closing control of the shutoff valve 211a′, etc. on the basis of the detection signal of this sensor, or a detection signal of the pressure sensor 211b or the temperature sensor 211c.

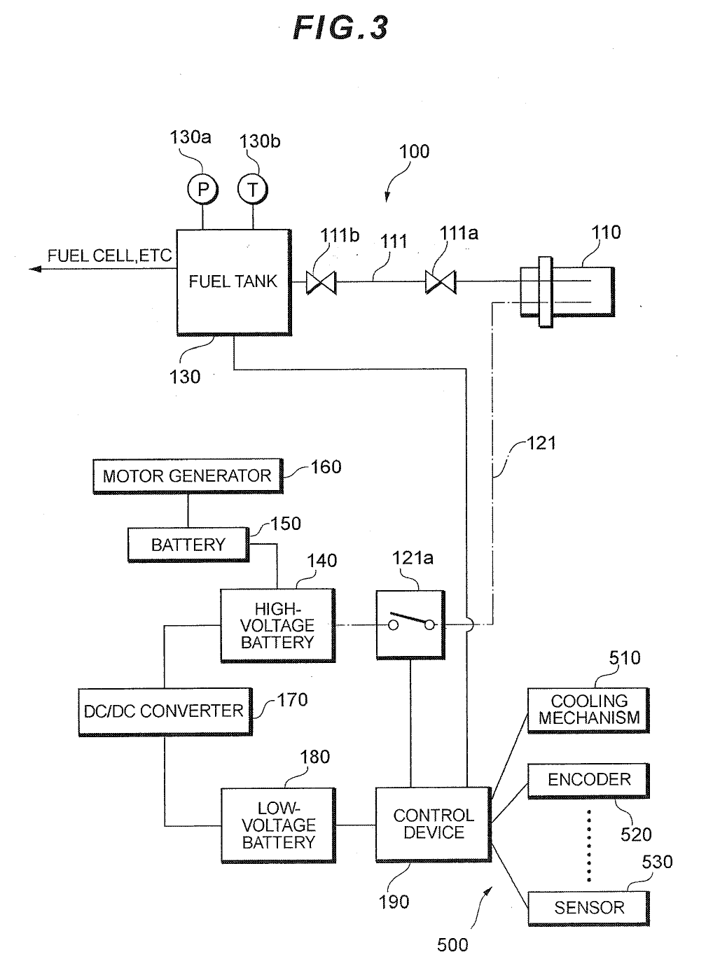

FIG. 3 is a view illustrating a construction on the side of the fuel cell automobile 100. The fuel receptacle 110 provided in the fuel cell automobile 100 is provided inside a fuel lid (not shown) disposed at the surface of a vehicle body of the fuel cell automobile 100, and the distal end of the fuel supply channel 111 and the distal end of a power supply channel 121 are integrated by the fuel receptacle 110.

While the fuel supplied from the fuel supply device 200 is stored in a fuel tank 130 via the fuel supply channel 111 from the fuel receptacle 110, the electric power supplied from the fuel supply device 200 is supplied to a high-voltage battery (battery) 140 via the power supply channel 121 from the fuel receptacle 110.

The fuel tank 130 is a tank which reserves the fuel supplied from the fuel supply device 200 under high pressure. Here, although a high-pressure hydrogen tank is assumed as the fuel tank 130, a hydrogen storing alloy tank, etc. is also conceivable. The fuel supply channel 111 from the fuel receptacle 110 to the fuel tank 130 is provided with a shutoff valve 111a for electromagnetic control, a source valve 111b used as an inlet to the fuel tank 130, etc.

Meanwhile, the fuel tank 130 is provided with a pressure sensor 130a which detects the internal pressure of the fuel tank to outputs a pressure signal, and the temperature sensor 130b which detects the internal temperature of the fuel tank to output a temperature signal, and the respective signals are supplied to the control device 190. The control device 190 performs opening/closing control of the shutoff valve 111a, the source valve 111b, etc. on the basis of the signal supplied from each sensor.

The high-voltage battery 140 functions as a power supply source for traveling, and is connected to a motor generator 160 via an inverter 150. As the high-voltage battery 140, for example, a nickel-hydrogen battery, a lithium ion battery, or a capacitor can be employed. The power supply channel 121 from the fuel receptacle 110 to the high-voltage battery 140 is provided with a switch 121a which controls power supply to the high-voltage battery 140. The control device 190 detects whether or not the nozzle 240 is connected to the fuel receptacle 110, on the basis of a detection signal fed from a sensor which is not shown. When the control device 190 detects that the nozzle 240 is connected to the fuel receptacle 110 and supply of fuel and supply of electric power has become possible, the control device monitors the charging rate (SOC) of the high-voltage battery 140, and determines whether or not the supply of electric power from the fuel supply device 200 is received.

For example, if the charging rate (SOC) of the high-voltage battery 140 is below a preset reference value V1, the control device 190 turns on the switch 121a to receive supply of electric power from the fuel supply device 200. On the other hand, if the charging rate (SOC) of the high-voltage battery 140 exceeds the reference value V1, the control device turns off the switch 121a to shut off supply of the electric power from the fuel supply device 200.

The control device 190 controls supply of the electric power to the high-voltage battery 140 in this way. In addition, the supply amount, reference value V1, etc. of electric power to the high-voltage battery 140 may be suitably changed according to user's operation, etc.

The motor generator (power consumption device) 160 generates a driving force to be given to a driving wheel (not shown) by the electric power supplied from the high-voltage battery 140. In addition, the motor generator 160 may have a function as an electric generator in addition to a function as an electric motor (motor).

Specifically, in a case where the motor generator 160 functions as an electric motor, the electric power which is stored in the high-voltage battery 140 is supplied to the motor generator 160 via the inverter 150. Driving control of the motor generator 160 at this time is performed by the control of the inverter 150.

On the other hand, in a case where the motor generator 160 functions as an electric generator, generated electric power is fed to the high-voltage battery 140 via the inverter 150. At this time, the electric-generating capacity of the motor generator 160 is adjusted by adjusting the electric energy to be fed to the high-voltage battery 140 via the inverter 150.

Additionally, a DC/DC converter 170 which is a power converter is connected to the high-voltage battery 140. This DC/DC converter 170 plays a role in stepping down the output voltage of the high-voltage battery 140, and supplying electric power to a low-voltage battery 180 connected.

The low-voltage battery 180 serves as a power supply source to respective accessories (power consumption device) 500, such as a cooling mechanism (temperature adjusting mechanism) 510 for cooling the fuel tank 130 when fuel is supplied, etc., an air-conditioner 520, and various sensors 530.

The control device 190 adjusts the power supply from the high-voltage battery 140 to the low-voltage battery 180 while monitoring the charging rate (SOC) of the low-voltage battery 180, and adjusts the power supply of the respective accessories 500 from the low-voltage battery 180.

Additionally, when the control device 190 detects that the nozzle 240 is connected to the fuel receptacle 110 and supply of fuel and supply of electric power has become possible, the control device monitors the charging rate (SOC) of the low-voltage battery 180, and determines whether or not the supply of electric power from the high-voltage battery 140 is received.

For example, if the charging rate (SOC) of the low-voltage battery 180 is below a preset reference value V2 (<V1), the control device 190 performs control such that electric power is supplied to the low-voltage battery 180 from the high-voltage battery 140 via the DC/DC converter 170. On the other hand, if the charging rate (SOC) of the low-voltage battery 180 exceeds the reference value V2, the control device performs control such that electric power is not supplied to the low-voltage battery 180 from the high-voltage battery 140.

The control device 190 controls supply of the electric power to the low-voltage battery 180 from the high-voltage battery 140 in this way. In addition, the supply amount, reference value V2, etc. of electric power to the low-voltage battery 180 may be suitably changed according to user's operation, etc.

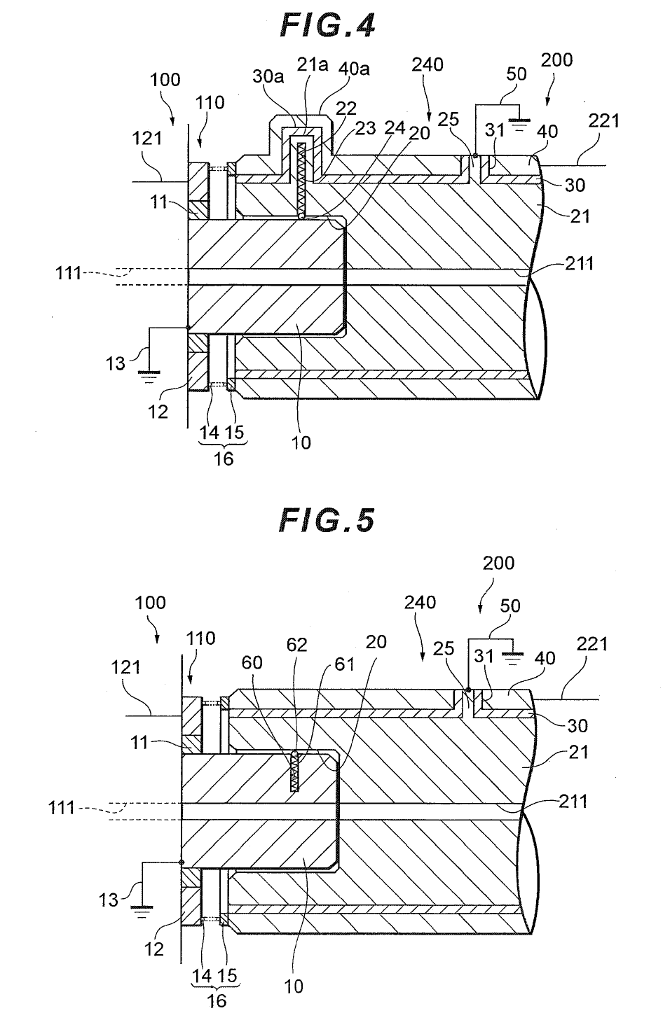

Also, the first embodiment of the receptacle is constituted by the nozzle 240 of the aforementioned fuel supply device 200, and the fuel receptacle 110 of the fuel cell automobile 100. As shown in FIG. 4, the fuel receptacle 110 of the fuel cell automobile 100 has a projection-like conductive portion 10, which protrudes substantially in a cylindrical shape and is made of a conductive material, at the outside thereof, and the center of the projection-like conductive portion 10 is formed with the fuel supply channel 111.

Additionally, in the fuel receptacle 110, an insulating portion 11 which is made of an annular insulating material and is formed over a whole outer periphery of the projection-like conductive portion 10 on its proximal side, and a conductive portion 12 which constitutes a portion of the power supply channel 121 and is made of an annular conductive material is formed at an outer periphery of the insulating portion 11. This permits the projection-like conductive portion 10 and the conductive portion 12 to be electrically insulated by the insulating portion 11. The projection-like conductive portion 10 is grounded to a vehicle body via a ground line 13.

In addition, the fuel receptacle 110 has conductive biasing portion 16 including a coil spring 14 which is coaxially joined to the outside of the annular conductive portion 12 and is made of a conductive material, and a ring 15 which is joined to a distal end of the coil spring 14 and is made of an annular conductive material.

The nozzle 240 of the fuel supply device 200 has a fitting hole 20 made to fit to the projection-like conductive portion 10 of the fuel receptacle 110 formed at one end thereof. Thereby, a substantially cylindrical conductive portion (first conductive portion) 21 which contains the projection-like conductive portion 10 when being connected, and is made of a conductive material, and a distal end of the fuel supply channel 211 is formed at the inside of the conductive portion 21 so as to be opened to a bottom of the fitting hole 20.

The fuel supply channel 211 is connected to the fuel supply channel 111 of the fuel cell automobile 100 at the time of connection when the fitting hole 20 is fitted to the projection-like conductive portion 10, and performs supply of fuel to the fuel cell automobile 100. In addition, a seal portion (not shown) is provided between the projection-like conductive portion 10 and the fitting hole 20 such that the fuel supply channels 111 and 211 is not opened to the outside via a gap between the conductive portion and the fitting hole.

Additionally, a hole 22 opened to an inner wall of the fitting hole 20 is formed along a radial direction in the conductive portion 21. In order to secure the depth of the hole 22, the conductive portion 21 is formed with a protruding portion 21a which protrudes in a direction opposite to an opening of the hole 22. A coil spring (elastic body) 23 made of a conductive material is inserted into the hole 22, and, and the coil spring 23 has one end joined to a bottom of the hole 22.

A spherical body 24 made of a conductive material is joined to the other end of the coil spring 23, and when the coil spring 23 is in a free state, the spherical body 24 protrudes by a predetermined distance from the opening of the hole 22.

A substantially cylindrical insulating portion 30 made of an insulating material is concentrically formed on the outer peripheral side of the conductive portion 21 almost over its entire periphery, and a substantially cylindrical conductive portion (second conductive portion) 40 made of a conductive material is formed at an outer periphery of the insulating portion 30 almost over its entire periphery. In addition, a protruding portion 30a is formed even in the insulating portion 30 so as to cover the protruding portion 21a of the conductive portion 21, and a protruding portion 40a is formed even in the conductive portion 40 so as to cover the protruding portion 30a.

The conductive portions 40 constitute a distal end of the power supply channel 221. In addition, the insulating portion 30 is such that the cylindrical portion 31 that is a portion thereof passes through the conductive portion 40 in the radial direction. As a result, a through portion 25 of the conductive portion 21 in an innermost layer passes through the conductive portion 40 in the radial direction in a state of being electrically insulated via the inside of the cylindrical portion 31. A ground line 50 which grounds the conductive portion 21 is connected to the through portion 25.

Here, as described above, the fuel supply channel 211 of the fuel supply device 200 is connected to the fuel supply channel 111 of the fuel cell automobile 100 at the time of connection when the projection-like conductive portion 10 of the fuel receptacle 110 is fitted to the fitting hole 20 of the nozzle 240. At this time, the spherical body 24 provided in the fitting hole 20 of the nozzle 240 will ride on an outer peripheral surface of the projection-like conductive portion 10 while it contacts the projection-like conductive portion 10 to retract the coil spring 14.

Additionally, at this time, a distal face of the conductive portion 40 on the outer peripheral side of the nozzle 240 abuts on the ring 15 of the biasing portion 16 of the fuel receptacle 110 to retract the coil spring 14. Then, the biasing portion 16 is connected to the conductive portion 40 while biasing the nozzle 240 of the fuel supply device 200 in a direction opposite to the connection direction, thereby electrically connecting the power supply channel 221 of the fuel supply device 200 and the power supply channel 121 of the fuel cell automobile 100.

According to the first embodiment of such a receptacle, when the nozzle 240 of the fuel supply device 200 is connected to the fuel receptacle 110 of the fuel cell automobile 100, the conductive portion 21 inside the fuel supply device 200 will contain the projection-like conductive portion 10 of the fuel receptacle 110, thereby performing fuel supply to the fuel supply channel 111 of the fuel cell automobile 100 via the inner fuel supply channel 211. Additionally, the conductive portion 40 on the outer peripheral side which is provided so as to be electrically insulated by interposing the insulating portion 30 on the outer peripheral side of the conductive portion 21 contacts the biasing portion 16 of the power supply channel 121, thereby performing external power supply to the fuel cell automobile 100 from the power supply source 220.

Consequently, the fuel cell automobile 100 can receive external power supply in accordance with supply of fuel. This prevents the low-voltage battery 180 and the high-voltage battery 140 of the fuel cell automobile 100 from being exhausted even if the accessories 500, such as the cooling mechanism 510, the air-conditioner 520, and the sensor 530, of the fuel cell automobile 100 are operated when fuel is supplied.

Additionally, since the inner conductive portion 21 is grounded by the ground line 50, static electricity can be removed when being connected with the fuel receptacle 110. Moreover, the fuel supply device 200 has a simple structure which insulates the conductive portion 21 which performs fuel supply to the fuel cell automobile 100, and the conductive portion 40 which performs external power supply to the fuel cell automobile 100 by the insulating portion 30.

Accordingly, since the low-voltage battery 180 and the high-voltage battery 140 of the fuel cell automobile 100 is prevented from being exhausted when fuel is supplied, the operation stability of the fuel cell automobile 100 after the fuel is supplied can be improved. Additionally, static electricity can be removed at the time of connection between the fuel supply device 200 and the fuel cell automobile 100. Moreover, the structure of the fuel supply device 200 can be made simple.

Additionally, since the conductive portion 21 inside the nozzle 240 of the fuel supply device 200 is provided with the conductive spherical body 24, and the conductive coil spring 23 which biases the spherical body 24 in the direction of the fuel receptacle 110, the conductive spherical body 24 of the conductive portion 21 is biased by the conductive coil spring 23 and is connected to the fuel receptacle 110 well, so that static electricity can be removed by the ground lines 13 and 50.

Next, a second embodiment of the receptacle related to the invention will be described mainly about portions different from the first embodiment with reference to FIG. 5.

In the second embodiment, the nozzle 240 of the fuel supply device 200 is not provided with the spherical body 24, the coil spring 23, the hole 22, and the protruding portions 21a, 30a, and 40a of the first embodiment, and a construction equivalent to these is provided in the fuel receptacle 110 of the fuel cell automobile 100.

That is, radially, a hole 60 opened to an outer peripheral surface is formed along the radial direction in the projection-like conductive portion 10 of the fuel receptacle 110, and a coil spring (elastic body) 61 made of a conductive material is inserted into the hole 60. The coil spring 61 has one end joined to the bottom of the hole 60, and a spherical body 62 made of a conductive material is joined to the other end of the coil spring. The spherical body 62 protrudes by a predetermined distance from the opening of the hole 60 when the coil spring 61 is in a free state.

Even in such a second embodiment, at the time of connection when the projection-like conductive portion 10 of the fuel receptacle 110 is fitted to the fitting hole 20 of the nozzle 240, the conductive spherical body 62 provided at the projection-like conductive portion 10 of the fuel receptacle 110 will ride on an outer peripheral surface of the fitting hole 20 of the conductive portion 21 while it contacts the inner peripheral side of the conductive portion 21 of the nozzle 240 to retract the conductive coil spring 61, and is therefore connected to the conductive portion 21 well, so that static electricity can be removed by the ground lines 13 and 50.

In addition, in the first and second embodiments, the insulating portion 30 which electrically insulates the conductive portion 21 and the conductive portion 40 may be formed with an elastic body which performs biasing in any one direction of an axial direction and a radial direction such that the projection-like conductive portion 10 of the fuel receptacle 110 and the nozzle 240 are brought into contact with each other.

1. A receptacle comprising a structure for connecting a mobile object having a supply port with a fuel supply device connected to the supply port to supply the mobile object with fuel and external power,
wherein the fuel supply device is provided with a first conductive portion containing the supply port when being connected, having a fuel supply channel formed therein, and supplying the mobile object with the fuel via the fuel supply channel, a second conductive portion provided on the outer peripheral side of the first conductive portion to supply the mobile object with the external power when being connected, an insulating portion electrically insulating the first conductive portion from the second conductive portion, and a ground line grounding the first conductive portion.

2. The receptacle according to claim 1,
wherein the first conductive portion is provided with a conductive spherical body, and a conductive elastic body which biases the spherical body in a direction of the supply port.

3. The receptacle according to claim 1,
wherein the supply port is provided with a conductive spherical body, and a conductive elastic body which biases the spherical body in a direction of the first conductive portion.

4. The receptacle according to claim 1,
wherein the mobile object is provided with conductive biasing portion connected to the second conductive portion while biasing the fuel supply device in a direction opposite to a connection direction.

5. The receptacle according to claim 1, wherein the fuel supply device supplies a battery or an accessory of the mobile object with the external power via the second conductive portion.

6. The receptacle according to claim 1, wherein the first conductive portion is a projection-like conductive portion which protrudes in a substantially cylindrical shape, and the fuel supply channel in the center of the projection-like conductive portion.

7. The receptacle according to claim 1, wherein static electricity is removed via the ground line at the time of connection between the first conductive portion and the supply port.
